(19) United States
(12) Patent Application Publication
(10) Pub. No.: US 2025/0191435 A1
(43) Pub. Date: Jun. 12, 2025

(54) FULLY AUTOMATED DRIVE-THROUGH BEVERAGE SHOP

(71) Applicant: David Thomas Zimmerman, LeClaire, IA (US)

(72) Inventor: David Thomas Zimmerman, LeClaire, IA (US)

(21) Appl. No.: 18/969,608

(22) Filed: Dec. 5, 2024

Related U.S. Application Data
(60) Provisional application No. 63/606,965, filed on Dec. 6, 2023.

(51) Int. Cl. G07F 13/06; A47F 10/02; G07F 9/00

(52) U.S. Cl. CPC G07F 13/065; A47F 10/02; G07F 9/006

(57) ABSTRACT

An automated beverage shop includes a building structure, a first vehicle lane, a kiosk positioned along the first vehicle lane configured for at least one of receiving a beverage order from a customer in a vehicle at the kiosk and matching an existing order to the customer in the vehicle at the kiosk, a drive-up window positioned along the first vehicle lane, and an automated beverage preparation control system disposed within the building structure wherein the automated beverage preparation control system is configured to: receive an order for one or more beverages; for each of the one or more beverages: determine a beverage container type for the beverage, prepare the beverage, convey the beverage to a beverage container of the beverage container type, convey the order for the one or more beverages to the drive-up window, and determine that the order has been received by the customer in the vehicle.

### PRIORITY STATEMENT

This application claims priority to Provisional Application No. 63/606,965, filed Dec. 6, 2023, hereby incorporated by reference in its entirety.

### FIELD OF THE INVENTION

The present invention relates to a fully automated drive-through beverage shop.

### Background in the Art

A drive-up coffee shop typically has a small, compact layout that is designed for speed and convenience. Customers drive up to a window or kiosk to place their order and receive their coffee or espresso drink. The menu options are usually limited to a few popular items, and the emphasis is on to-go orders rather than sit-down service. The size of the shop is often small, with limited seating or no seating at all. Drive-up coffee shops are often located in high-traffic areas, such as busy intersections or near highways.

Drive-up coffee shops are a popular choice for people who are on-the-go and want a quick and convenient way to receive their beverage. A drive-up coffee shop typically has a limited menu that focuses on popular coffee and espresso drinks. Customers can expect to find options such as lattes, cappuccinos, americanos, and drip coffee. Some drive-up coffee shops may also offer iced coffee, cold brew, and specialty drinks such as mochas or caramel macchiatos. The emphasis is on to-go orders, so customers can expect their drinks to be served in disposable cups with lids. Some drive-up coffee shops may also offer a small selection of pastries or snacks to go along with their drinks. The menu options may vary depending on the location and the time of day, with some drive-up coffee shops offering breakfast items in the morning and switching to a lunch menu later in the day.

Despite the benefits of drive-up coffee shops, problems remain. One problem relates to the staffing of drive-up coffee shops. A drive-up coffee shop may be very small and cramped and thus for many individuals not a preferred work environment. In a small drive-up coffee shop if only a single worker is present there may be concerns about their personal safety. Where a single individual is required to perform all aspects of operating the shop, it may be more difficult to recruit suitable candidates and to train them in order to make all drinks with all variations as quickly as possible. Where multiple workers are present, the operational costs will increase, and multiple workers may not actually be needed at non-peak hours of operations. If workers are late or do not show up for their assigned shifts, then the coffee shop cannot operate or will function poorly which can result in loss of revenue.

Despite investment in worker training, workers may be slow, may prepare drinks in an inconsistent manner, make mistakes in the ordering process or drink preparation process, or may otherwise provide a less than desired level of service which may result in a negative impact on the business, loss of customer loyalty, or other adverse effects.

Such problems could generally be addressed with a fully automated drive-through beverage shop, but there are numerous technical problems and challenges associated with a fully automated drive-through beverage shop.

Such problems include problems in developing an ordering process which may be sufficiently synchronized with the beverage preparation and delivery process. In order for a fully automated system to work, orders must be collected and prioritized so that beverages are made in the right order. In addition, customers must receive the correct orders.

Additional technological problems relate to the safety of beverage preparation. Where automation is used to prepare and deliver drinks, the preparation and delivery must be performed in a safe and effective manner. This includes, for example, making sure beverages are not too hot, that container lids are secured.

### SUMMARY OF THE INVENTION

Therefore, it is a primary object, feature, or advantage to improve over the state of the art.

It is a further object, feature, or advantage to provide a fully automated drive-up beverage shop which does not use workers to take orders or prepare drinks.

It is a still further object, feature, or advantage to provide a fully automated drive-up beverage shop which allows customers to obtain their beverages without interacting with employees.

Another object, feature, or advantage is to provide beverages of consistent quality and ingredients.

Yet another object, feature, or advantage is to provide a drive-up beverage shop with a small and compact layout designed for a small footprint.

Another object, feature, or advantage is to provide a drive-up beverage shop with a layout designed for speed and convenience.

A further object, feature, or advantage is to provide a fully automated drive-up beverage shop which applies technology to solve technical problems and challenges.

A still further object, feature, or advantage is to provide a fully automated drive-up beverage shop which uses automated processes to receive beverage orders.

A still further object, feature, or advantage is to provide a fully automated drive-up beverage shop which uses automated processes to receive payments for beverage orders.

Another object, feature, or advantage is to provide a fully automated drive-up beverage shop which uses automated processes to prioritize orders.

Yet another object, feature, or advantage is to provide a fully automated drive-up beverage shop which minimizes wait time for customers.

A further object, feature, or advantage is to provide a fully automated drive-up beverage shop which interacts with customers in a safe manner.

A still further object, feature, or advantage is to provide a fully automated drive-up beverage shop which may be remotely monitored.

One or more of these and/or other objects, features, or advantages will be apparent from the specification and claims that follow.

According to one aspect, an automated beverage shop includes a building structure, a first vehicle lane, a kiosk positioned along the first vehicle lane configured for at least one of receiving a beverage order from a customer in a vehicle at the kiosk and matching an existing order to the customer in the vehicle at the kiosk, a drive-up window positioned along the first vehicle lane, and an automated beverage preparation control system disposed within the building structure wherein the automated beverage preparation control system is configured to: receive an order for one or more beverages; for each of the one or more beverages: determine a beverage container type for the beverage, prepare the beverage, convey the beverage to a beverage container of the beverage container type, convey the order for the one or more beverages to the drive-up window, and determine that the order has been received by the customer in the vehicle.

According to another aspect, a system for managing a plurality of automated beverage shops includes a mobile app for use by customers to place beverage orders and a remote server in operative communication with the mobile app wherein the remote server includes an ordering module for receiving orders through the mobile app, a membership module for managing members of users placing beverage orders, and a monitoring module for managing one or more robotic cells at each of the plurality of automated beverage shops.

According to yet another aspect, a method of managing an automated beverage shop includes collecting beverage orders using a mobile app, wherein each of the beverage orders comprises a pick-up time, prioritizing the order at least partially based on the pick-up time, controlling one or more robotic cells in order to automatically prepare each beverage of the beverage orders, and robotically delivering each of the one or more beverage orders to a customer associated therewith.

According to another aspect, a method of managing an automated beverage shop includes collecting beverage orders using a mobile app, wherein each of the beverage orders comprises a pick-up time. The method further includes dynamically scheduling preparation of the order at least partially based on the pick-up time and changes in the pick-up time. The method further includes controlling one or more robotic cells in order to automatically prepare each beverage of the beverage orders. The method further includes maintaining each beverage of the beverage orders while awaiting pickup. The method further includes robotically delivering each of the one or more beverage orders to a customer associated therewith. The method may further include determining that at least one beverage of the beverage orders is outside of a predetermined temperature range while awaiting pickup, disposing of the at least one beverage and dynamically scheduling preparation of a replacement beverage prior to pick-up.

### BRIEF DESCRIPTION OF THE FIGURES

FIG. 1 illustrates one example of a configuration for a physical layout of an automatic beverage shop.

FIG. 2 is a block diagram illustrating one example of a robotic cell.

FIG. 3 is a block diagram of one example of a system.

### DETAILED DESCRIPTION

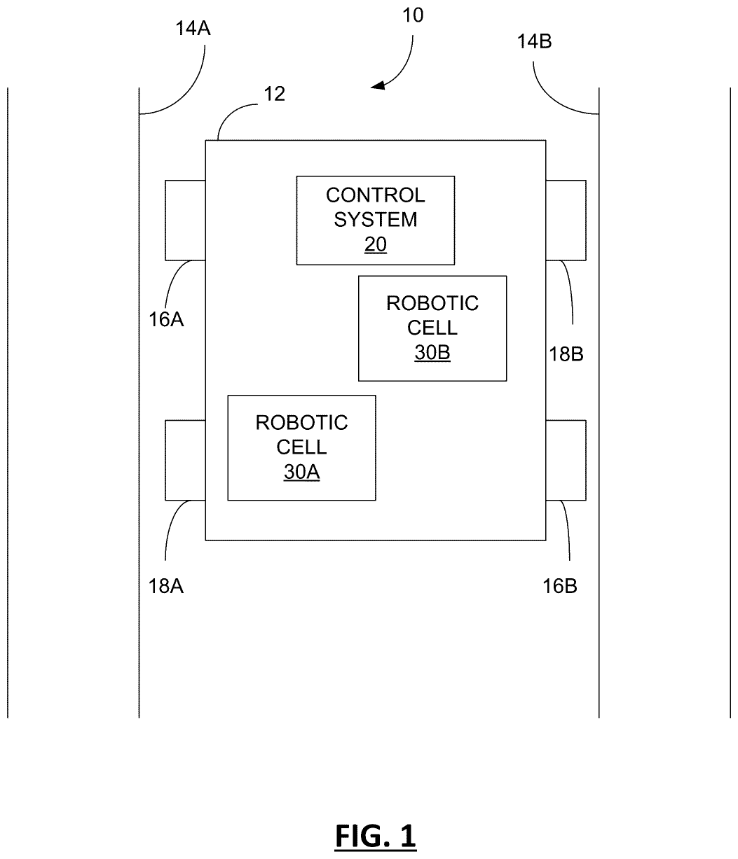

FIG. 1 illustrates one example of a physical layout for an automated beverage shop 10. The automated beverage shop 10 may include a building structure 12. The building structure 12 may be of different sizes, shapes, configurations, and layout. Generally, however, it is preferred that the building structure 12 be relatively small in size. Because the automated beverage shop 10 does not rely upon employees to prepare beverages, and is drive-through, and is not open to the public, the building structure may be small in size and need not include indoor or outdoor seating, public or private restrooms, or other features associated with conventional coffee shops or restaurants unless required by local code or ordinances. The building structure may include storage areas for supplies, waste consolidation areas, or other areas.

A first vehicle lane 14A is shown which runs along one side of the building structure 12. Although the first vehicle lane 14A is shown as straight, it may have a curved path or may extend around a corner in instances where the building structure has corners. The first vehicle lane 14A extends at least between a kiosk 16A and a drive-up window 18A so that an individual may place an order or provide identifying information for the order or the individual at the kiosk 16A and may then pick-up their order at the drive-up window 18A. Although the kiosk 16A is shown at the side of the building structure 12, it may be separated from the building structure 12. The kiosk 16A and drive-up window 18A are spaced apart such that one vehicle may be at the kiosk 16A while another vehicle may be at the drive-up window 18A. In some embodiments, the kiosk 16A may be spaced apart further from the drive-up window to allow for additional vehicles to queue between the kiosk 16A and the drive-up window 18A. In some configurations a second vehicle lane 14B is present which in some embodiments may allow for traffic in the opposite direction. In other configurations, the second vehicle lane 14B may allow for traffic flow in the same direction as the first vehicle lane 14A. There is a second kiosk 16B associated with the second vehicle lane 14B and a second drive-up window 18B associated with the second vehicle lane 14B. In some configurations, the first vehicle lane 14A and the second vehicle lane 14B are used for the same purpose. In other configurations, the first vehicle lane 14A and the second vehicle lane 14B may be used for different purposes. For example, the first vehicle lane 14A may be for express pick-up where orders have been already placed in advance while the second vehicle lane 14B may be for ordering at the time of pickup instead of in advance. In other examples, the first vehicle lane 14A may be for members only while the second vehicle lane 14B may be used by non-members. In such configurations, the first vehicle lane 14A may usually allow for quicker delivery of drink orders.

Within the building structure 12 are an automated beverage preparation control system 20 which will be described in more detail and is used to control the process of preparing beverages. In addition there may be one or more robotic cells 30A, 30B which are used to prepare beverages. There may be a single robotic cell associated with each vehicle lane or there may be multiple robotic cells associated with each vehicle lane. In some embodiments, a single robotic cell or each of a plurality of robotic cells may be able to prepare beverages for more than one vehicle lane.

Although a particular example of an automated beverage shop is shown in FIG. 1, it should be appreciated that a number of different options and variations are contemplated including with respect to the layout, the number of vehicle lanes, the placement of vehicle lanes, the number of kiosks, the placement of kiosks, the number of drive-up windows, the placement of drive-up windows, the number of robotic cells and other variations. Additional variations in the building structure may be present such as to minimize the footprint of the building structure, to comply with applicable building code requirements or local ordinances. In some embodiments, the building structure may be designed to be an energy efficient, carbon and cost saving green building. For example, solar panels may be used on the roof of the building or may otherwise be positioned at or near the building structure. Frameworks associated with LEED or other organizations may be applied in order to demonstrate and/or certify the use of such principles.

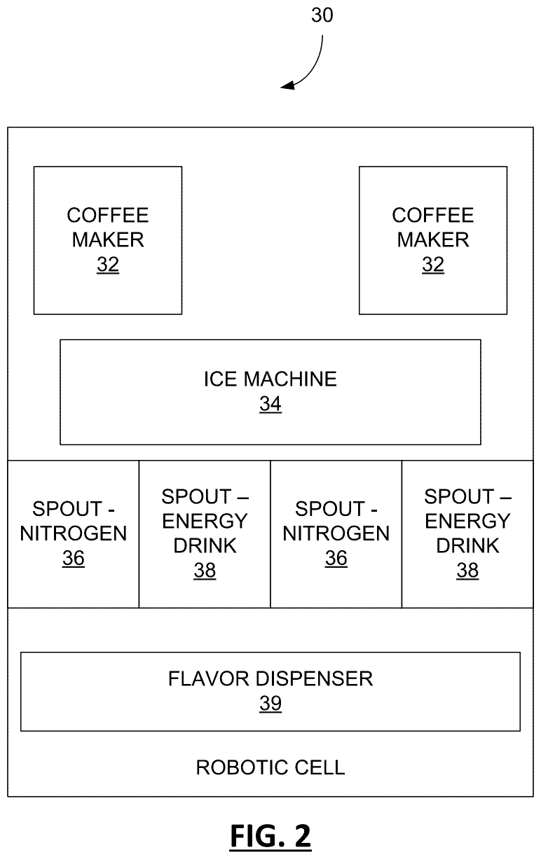

FIG. 2 illustrates one example of a robotic cell 30 in more detail. The robotic cell 30 of FIG. 2 may correspond to robotic cells 30A, 30B in FIG. 1. Returning to FIG. 2, the robotic cell 30 includes a first and second coffeemaker 32 and an ice machine 34. The robotic cell 30 may also include a plurality of draft spouts. The draft spouts may include spouts for dispensing nitrogen for a cold brew such as nitrogen spouts 36. The draft spouts may further include spouts for dispensing draft energy drinks such as energy drink spouts 38. A flavor dispenser 39 may also be present for dispensing flavoring agents for the drinks. The flavor dispenser 39 may dispense a plurality of different flavoring agents such as a plurality of different syrups for flavoring the coffee or energy drinks. Examples of different syrups which may be used for flavoring coffee include, without limitation, hazelnut, vanilla, caramel, mocha, almond, coconut, toffee, cinnamon, nutmeg, cardamom, peppermint, chocolate, butterscotch, amaretto, macadamia, espresso, Irish cream, white chocolate, pumpkin spice, hazelnut, salted caramel, banana. Energy drinks may use the same flavoring as for coffee or other types of flavorings such as, without limitation, lemon, lime, orange, grapefruit, raspberry, blueberry, strawberry, cranberry, blackberry, mango, pineapple, passionfruit, guava, acai, ginger, mint, honey, maple, coffee, cocoa, cola, and root beer.

The first coffee maker 32 and the second coffee maker 32 may be configured to brew coffee. In some embodiments, different coffee makers may brew different types of coffee beans such as Arabica, Robusta, Liberica, Excelsa, or other types of coffee beans. In some embodiments, the first coffee maker 32 and the second coffee maker 32 may be configured to brew espresso using Espresso beans. In some embodiments, the coffee maker may also provide for adding milk, cream, or sweetener directly.

The robotic cell 30 may implement a multi-zone temperature monitoring and control system using an array of infrared temperature sensors positioned at specific preparation stages. The control system may maintain optimal beverage temperature by dynamically adjusting heating or cooling elements based on real-time temperature readings and predicted wait times until customer pickup.

A distributed sensor network within each robotic cell monitors preparation quality parameters such as liquid level sensors using ultrasonic measurement, flow meters measuring liquid discharge rates, pressure monitors monitoring espresso extraction, load cells measuring ingredient portions, optical sensors detecting proper lid placement and security.

The robotic cell may include a six-axis articulated robotic arm. The arm's end effector may include a pneumatic gripper system with variable pressure control, integrated proximity and force sensors for precise container handling, an optical system for container alignment and lid verification, and temperature-isolated gripping surfaces to maintain beverage temperature.

The control system 20 may implement a real-time scheduling algorithm that optimizes order preparation using a modified earliest deadline first (EDF) scheduling approach. The algorithm considers multiple factors including: predicted preparation time for each beverage type (based on historical data), current queue length and system utilization, customer arrival time predictions (based on mobile app location data), required temperature maintenance time, and resource availability across robotic cells.

One such an example of an algorithm involves a scheduling system which maintains a dynamic priority queue where each order's priority P is calculated as:

P=(W1*T_pickup)+(W2*T_prep)+(W3*Q_length)+(W4*R_avail)
where:
   T_pickup is time until scheduled pickup
   T_prep is estimated preparation time
   Q_length is current queue length
   R_avail is resource availability factor
   W1-W4 may be dynamically adjusted weights based on historical performance data

It is to be understood that implementation of a dynamic priority queue such as in the example above may be implemented by the control system, by the remote server, or by the control system working in collaboration with the remote server. The historical performance data may be data from a single beverage shop or a collection of beverage shops.

The control system may implement a three-tier safety verification process for each beverage which includes pre-preparation verification to check ingredient availability, temperature, and equipment readiness; in-process monitoring to provide continuous verification of preparation parameters including temperature, volume, and mixture ratios; and post-preparation verification to provide final quality check including lid security, temperature, and fill level. Such a methodology may be used to ensure that each beverage is properly prepared according to a customer's order.

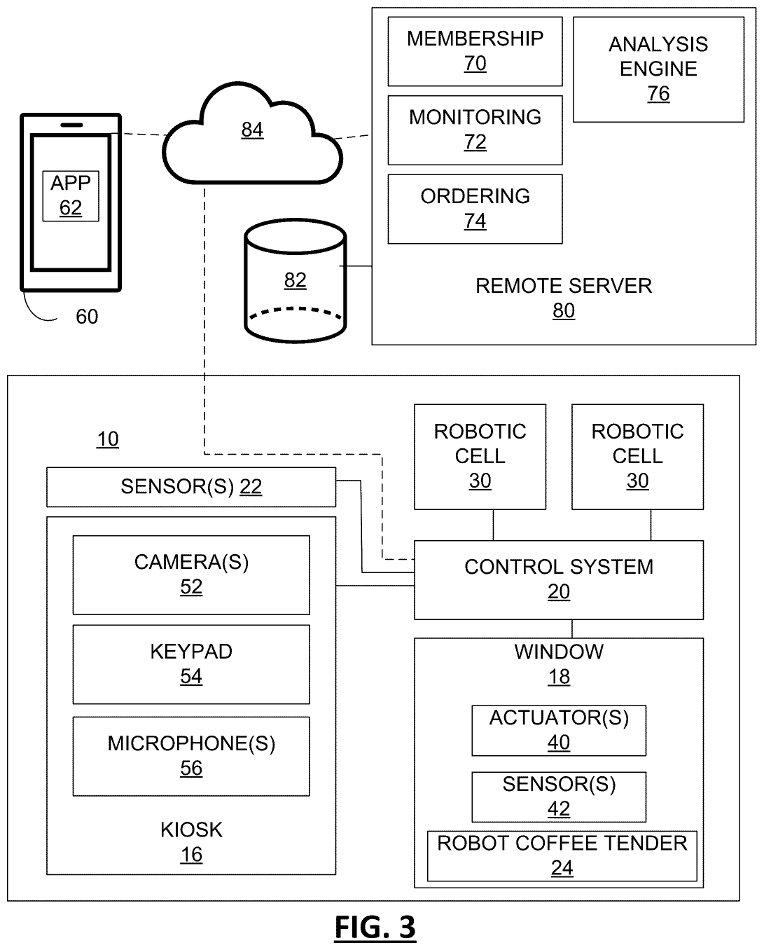

FIG. 3 provides an overview of a system of the automated beverage shop 10. The automated beverage preparation control system 20 is shown which is operatively connected to one or more robotic cells 30. The automated beverage preparation control system 20 receives orders through the cloud 84 and/or directly through a kiosk 16. A mobile device 60 with a software application (“app”) 62 executing instructions using a processor is also shown. The app 62 may include a plurality of instructions which when executed allow a user to place a beverage order. The app 62 may be cloud-based app. The app 62 may be a native app, a web app, or a hybrid app. The mobile device 60 may connect over the cloud 84 to a remote server 80. The remote server 80 is a system which may include one or more hardware or virtual servers or clusters of servers which amongst other functions may provide for hosting data and services related to the mobile app 62, as well as operations of the automated beverage shop. It is to be further understood that the remote server 80 is saleable and may service any number of different customers and any number of different automated beverage shops. A database 82 is shown which is in operative communication with the remote server 80. The database 82 may be a single database or multiple databases and may be distributed across locations. The database 82 may be used to store data associated with back-end operations of the app 62, the automated beverage shop 10, or other data. The data may include historical performance data which is used in adjusting weights of a dynamic priority queue or other dynamically scheduling algorithm.

The remote server 80 may include any number of different modules. These may include a membership module 70, a monitoring module 72, and an ordering module 74.

The membership module 70 may be configured to store and maintain membership and subscription information. Different membership and subscription models are contemplated. In one membership or subscription model a set fee (e.g., a monthly or weekly subscription fee) is paid which entitles the member/subscriber to a particular number of retrievals. This may be zero retrievals or quantities. In such an example, the membership fee would be required for the opportunity to order beverages and beverage prices would be paid in addition. In an opposite example, there may be a monthly or weekly fee which entitles the individual to an effectively infinite number of beverages. In such a model, there may be additional restriction or requirements such as to limit the number of beverages per order (e.g., one beverage per visit for an individual subscription), limit the number of trips per day, limit the number of beverages per day, or other limitations or restrictions which encourage individuals to act within reasonable limits. In other models, there may be a set price for a certain number of beverages or a certain value of beverages. For example, an individual may pay a $25 subscription fee a week for up to $35 in beverage value per week. In some embodiments, unused credit may expire after each subscription period. In other embodiments, unused credit may roll over to the next for a period of time or up to a maximum credit amount.

This subscription model is advantageous in a number of different regards. In addition to encouraging customer loyalty and a recurring revenue stream, the subscription model in combination with customer order history or other information allows the remote server to make informed predictions regarding various aspects of the automated beverage shop. This may include making predictions as to when onsite service is required for equipment maintenance, inventory delivery, or waste removal. The subscription model encourages customers to develop patterns which may be detected and utilized in such predictions. The remote server 80 may do so in any number of ways. In some embodiments a neural network model may be used with unsupervised or semi-supervised learning to take available data and make predictions. In addition to order history and subscription information, additional data may be taken into account including seasonal and weather information, street traffic data, holiday data, and other information which may affect the predictions. In some embodiments, subscribers using the app 62 may also consent to sharing additional information about themselves or their habits or acquiring such data from data brokers or other third parties. This information may include demographic data, location data, occupational data, vehicle data, or other data. In some embodiments a neural network model or other type of machine learning model or statistical model may be used in order to generate recommendations and/or special orders at the time of ordering. This may be based on identifying additional beverage flavorings or combinations that an individual may like. It may also be based at least in part to assist in maintaining adequate inventory levels at the remote server. For example, if measured or calculated levels of a hazelnut flavoring is low, then in order to extend the time period until inventory replacement, customers who often order hazelnut flavoring may be presented with options or alternatives before placing their order. Thus, the number of times a human operator must visit to restock or resupply may be decreased and/or the likelihood that an individual will be told that an order must be deleted or modified will be reduced or eliminated.

One or more AI, machine learning, or statistical models may be executed using the analysis engine 76. Although neural network models have been described as one type of model, it is to be understood that any number of different types of models may be used depending upon the data available, the amount of data, the computing resources available or budgeted to perform such functionality or other relevant considerations.

A monitoring module 72 is also shown at the remote server 80. The monitor module 72 allows for an operator to monitor one or more automated beverage shops. For example, in some embodiments, a single individual (or more) may monitor a plurality of different automated beverage shops dispersed throughout a metropolitan area. The role of the individual may be to deliver and replace inventory, perform maintenance, monitor security, or related functions. Given the automated nature of the beverage shops, there need not be a separate person for each location and a single person may monitor and support multiple locations. Such an individual may be referred to herein as a manager. The manager may access data or functionality associated with the remote server 80 through a computing device operatively connected to the cloud 84. In some embodiments, the manager may use a special purpose app to do so. It is also to be understood that additional users may have different access rights and may access different aspects of the remote server or the database 82. For example, the remote server may provide various types of financial reporting which may be accessed by an individual in the role of an accountant. In some embodiments, an individual may have owner access which may provide full access. In some embodiments, a franchisor may have special access rights such to monitor agreed upon information as between the owner and the franchisor. Of course, additional functionality may be provided by the remote server 80 which may include generating any number of different types of reports regarding orders, finances, robotic operation, inventory, or otherwise. In some embodiments, the remote server integrates with other tools and systems used by managers, owners, franchisors, accountants, or others in order to streamline operations and automate as much of the management and reporting as practical.

The ordering module 74 is used in placing orders and may interact with or communicate with the app 62. Thus a user interface of the app 62 may allow an individual to make and customize a beverage order. In addition, the individual may specify a time for pick-up or an estimated time window for pick-up. In some embodiments, the analysis engine 76 may predict an actual time of arrival and/or time of pick-up based on the information provided by the user, the past history of the user including differences between when the individual expected to pick-up and when they did. Other information may also include the location of the user at the time of making the order, whether inertial data from the mobile device includes that the user is likely driving in their vehicle or at rest, traffic data, predicted wait times at the automated beverage shop (if any) and/or other relevant data. The analysis engine 76 may apply a machine learning model, a statistical model, or other type of model in order to make the prediction. In some embodiments, the user will be informed of the beverage shop prediction and/or the reasons for the prediction and the user may be given an opportunity to revise their expected pickup time. In other embodiments, the ordering module 74 may simply adjust the predicted time of pick-up based on available data and application of appropriate models by the analysis engine 76.

Each order may be an order for one or more beverages such as the types described herein including coffee drinks, energy drinks, tea drinks, or other types of beverages. Orders may include drinks with multiple ingredients such as coffee, milk, espresso, sugar, syrup, flavorings, or other ingredients. In addition, orders may specify condiments such as sugar packets, creamer packets, straws, stir sticks, or other such items. In some instances, the ordering system may also provide for performing a financial transaction to pay for the beverage in advance such as through a payment gateway such as Apple Pay, Samsung Wallet, PayPal, Stripe, Square, or other payment gateway. In other embodiments, the user may pay at the time of pick-up. In other embodiments as previously described, there may be no separate charge for a particular beverage as the beverage falls within the benefits afforded by a subscription service.

Orders may be communicated from the ordering module 74 to the automated beverage preparation control system 20. The automated beverage preparation control system 20 provides for controlling the robotic cells 30, operations associated with the drive-up window 18, and communicates with the kiosk 16.

The kiosk 16 may be used in a variety of different ways. Where an order has already been placed, a customer may drive up to the kiosk to communicate information through the kiosk 16 which is used to identify the pre-order. In some embodiments, the customer may input their phone number, which is the phone number of a mobile phone they have with them. This input may be done with a keypad 54 on the kiosk which may be an on-screen keypad. In other embodiments, one or more cameras 52 may be used. The app may generate a QR code which encodes basic data or complete data about the order or the customer. The customer may hold the display of the phone with the QR code visible towards the one or more cameras 52 which capture the QR code and information about the order of the customer is extracted.

The kiosk 16 may include one or more microphones 56. It is contemplated that a customer may provide information to match their order by providing information such as their name, their order number, their phone number, or other information sufficient to identify their order. Such information may be transcribed to text. In some embodiments, a speaker and/or a display may be used to provide audio and/or visual instructions regarding the process, to show or confirm the order, or otherwise communicate with the customer.

In some embodiments it is contemplated that there may be multiple individuals within the vehicle each with their own order. In such instances, the kiosk 16 may provide an opportunity for each separate order associated with the vehicle to be identified at the kiosk 16.

In some embodiments, orders may be placed at the shop. It is to be understood that where a membership or subscriber model is used, a customer may be required to have a membership or be a subscriber in order to place an order. In such an instance, the customer may provide information identifying themself such as a phone number, membership information, or other information. In some embodiments, a customer may become a member by providing their phone number to the kiosk and then the kiosk will send them a text to collect the additional information needed for membership. Where the process is too lengthy, the customer may be instructed to pull out of the vehicle lane to complete their member or subscriber sign-up and place their order. Where the customer is already a member, the order may be placed. If there is a lengthy queue of prior orders, the customer may be asked to return in 5 minutes or 10 minutes, or another future time instead of waiting in the vehicle lane delaying others. In some embodiments, there may be different vehicle lanes for pre-orders or orders placed at the kiosk.

The beverage preparation control system (sometimes referred to as “control system”) 20 is used to control the preparation of beverages. In some embodiments, the control system includes logic for receiving orders from the ordering module 74, routing orders from the kiosk 16, to the ordering module 74. Various functionality regarding the control system 20 will be described, but it is to be understood that some of the logic performed may be performed at the remote server instead of the control system 20. The control system 20 provides for receiving and prioritizing orders. In some embodiments this is facilitated in part by the analysis engine 76. In one example, each order contains one or more beverages and a pick-up time. The control system 20 and/or the remote server 80 may sort the list by pick-up times. It is to be understood that the pick-up time may be a user specified pick-time which may be adjusted. More complicated systems of beverage preparation prioritization are also contemplated. Such systems may take into account efficiencies obtained through batch processing, or maximizing utilization of available robotic cells, or other considerations to improve overall efficiencies. Such systems may also take into account the ability to maintain a drink within a desired temperature range for a period of time.

It is to be understood, however, that the control system and/or the ordering module 74 of the remote server 80 function to determine the timing of beverage preparation activity. This may include determining when to start making coffee in order to meet a desired pick up time as specified by a customer through the app or otherwise. It is also to be understood that some orders will be premade and kept warm (or cold depending upon the beverages) until the customer arrives to pick them up. This functionality of storing or maintaining a beverage allows for preplanning is advantageous as it ensures value to customers especially club members or subscribers who wish to have a drink ready at a specified time or more importantly to eliminate or minimize wait time, while also being as efficient as possible and providing drinks at desired temperatures. One or more sensors 22 may be operatively connected to the control system. The one or more sensors 22 may include temperature sensors such as IR (infrared) thermometer sensors or other non-contact sensors for measuring temperature of a liquid within a container. Alternatively, the sensors may be contact sensors for measuring temperature of a container.

The control system 20 is electrically connected or otherwise in operative communication with each robotic cell. Information about the status of each robotic cell 30 may be communicated to the control system 20. Control information may be communicated from the control system 20 to each robotic cell 30. This may include coffee maker settings for a particular drink order, ice machine settings for a particular order, nitrogen or energy drink requirements, flavor preferences, size settings for an order, or any number of other settings associated with an order whether specified by a customer, inferred from the order, or otherwise determined.

Thus, the control system 20 is configured to receive an order for one or more beverages. For each of the one or more beverages, the control system may determine a beverage container type for the beverage. For example, the beverage container type may be Styrofoam, plastic, or otherwise. The beverage container type may also be of a particular size which may be based on the item ordered and/or customer selections for the size of the beverage. One or more of the robotic cells 30 are then used to prepare the one or more beverages including by conveying the beverage to the appropriate beverage container type. Next, the control system 20 may operate the drive-up window 18.

A robot coffee tender 24 may be used to pick up one or more beverage containers of prepared beverages and convey to the window. Various types of methods are contemplated for doing so. In one embodiment, beverages may be placed on a pushout tray. One or more actuators 40 may be used to open the window and allow the tray to be extended out through the window in order for the customer to pick up. One or more sensors 42 may be used to monitor this process. For example, the one or more sensors 42 may include a pressure sensor, force sensor, or other sensor to sense that the weight associated with the beverages has been removed from the tray. The tray may then be returned through the open window and the window may automatically close.

In another embodiment, the window 18 may be in the form of a discharge window vestibule which prevents a customer from reaching into the shop. One or more actuators 40 may be used to open a discharge window. The customer may then reach within the window vestibule to grab their beverages. The one or more sensors 42 may include pressure, force, or other sensors which indicate that the beverage has been removed. A beam sensor may also be present to confirm that the hands of the customer have been cleared from the window. The actuator(s) 40 may then be used to close the window.

It is to be further understood that the window 18 need not be a single window but may be an array of windows or doors. It is to be further understood that although the term window is used, it is used to indicate an opening and not to require transparency because as there is no barista present there is no need for the customer to look inside. Where there are a plurality of windows 18 or compartments, each may have its own independent door which may opened with an actuator 40 and each may sense when its contents have been removed using one or more sensors 42. Where there is an array of compartments, only one door or window is opened at a time, the door or window which contains the customer's orders. This is advantageous in that multiple orders may be prepared in advance, but not too far in advance, to reduce wait times.

In some embodiments, the robotic cell 20 will include a dispenser for beverage condiments, napkins, and will perform all packaging such as fitting each beverage with a lid. Beverage condiments are additional substances or ingredients that may be used to enhance or customize the taste of coffee or other beverages. Beverage condiments may be provided alongside the order according to the preferences of a customer. Common beverage condiments include sugar packets, artificial sweeteners such as saccharin or stevia), honey, creamer cups, milk, or cream containers, and stir sticks. In other embodiments, this functionality may be provided by separate devices under the control of the control system 20.

It is to be further understood that the control system 20 may continue to monitor the status of beverages up until pickup. This may include the temperature of the drink or temperature of the container. If beverages have not been picked up, have heated, or cooled too much while waiting, the control system 20 may provide for heating or cooling the drink, disposing of the drink, and or re-making the drink.

The remote server 80 also includes a monitoring module 72. The monitoring module 72 may be used to monitor all aspects of the automated coffee shop including operation of the robotic cells, and otherwise as previously described. In addition, the monitoring module 72 may be used to provide security monitoring associated with the automated coffee shop. This may include placement of cameras around the beverage shop including at the kiosk, at the window 18, and otherwise. It is contemplated that doing so will reduce vandalism and record it to help identify any security issues. It is also contemplated, that doing so will allow for confirmation that beverages are delivered appropriately at the right temperature (such as coffee which is not too hot) and that the customer safely received the beverage, the lids on the beverage were tight, and otherwise enhance safety to customers and reduce liability to owners or operators.

The remote server 80 may also implement a hierarchical control architecture with three distinct processing layers including a strategic layer, a tactical layer, and an operational layer. The strategic layer provides for long-term planning and resource allocation, inventory prediction and management, staff scheduling optimization (keeping in mind no staff need be present in normal operations, but staff can remotely monitor or periodically provide maintenance), maintenance planning, and business analytics. The tactical layer provides for medium-term optimization such as order queue management, resource allocation, temperature management, quality control. The operational layer provides for real-time control including robot motion control, safety monitoring, error detection and recovery, and sensor data processing. Other types of control architecture are contemplated.

In some embodiments, a method of managing an automated beverage shop includes collecting beverage orders using a mobile app, wherein each of the beverage orders comprises a pick-up time. The method further includes dynamically scheduling preparation of the order at least partially based on the pick-up time and adjusts scheduling and operations based on changes in the pick-up time, controlling one or more robotic cells in order to automatically prepare each beverage of the beverage orders, maintaining each beverage of the beverage orders while awaiting pickup, and robotically delivering each of the one or more beverage orders to a customer associated therewith. It is to be understood that the maintaining each beverage of the beverage orders may include maintaining each of the beverages of the or more beverage orders within an acceptable temperature range such that a drink intended to be served cold such as an iced tea, iced coffee, or iced energy drink remains cold while a drink intended to be served hot such as coffee maintains a desired temperature. Thus, for example, an ideal temperature for drinking coffee may be 140 to 155 degrees F. Lower temperatures may result in diminished taste and aroma while higher temperatures may scald customers and degrade coffee flavors. Similarly, an ideal temperature for drinking iced tea may be between 45 and 50 degrees F. so that the drink stays cold without being completely frozen which would diminish flavors, but cold enough to prevent ice from melting too quickly. For storing a hot drink, the temperature may be slightly hotter than the ideal temperature for drinking. For storing a cold drink, the temperature may be slightly cooler than the ideal temperature for drinking. It is to be further understood that a beverage order may include drinks which should be served and therefore stored or maintained at different temperatures. Maintaining and then serving drinks within defined temperature ranges based on the type of specific beverage and customer preferences assist in providing an optimal flavor profile, a proper dilution rate from ice (where present), food safety standards (such as not serving beverages too hot), and customer satisfaction.

Therefore, various systems, devices, and methods have been shown and described herein. Although specific embodiments and examples are described, it is to be understood that any number of combinations of features from different embodiments, as well as options, and alternatives are contemplated. The methods and functionality described herein, or aspects thereof may be incorporated into software in the form of instructions stored on a non-transitory computer or machine readable medium.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments may be described herein as implementing methodologies including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules. Where the term “processor” is used, it is to be understood that it encompasses one or more processors whether located together or remote from one other.

Similarly, some of the methods described herein may be at least partially processor implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a single beverage shop), while in other embodiments the processors may be distributed across a number of locations such as multiple beverage shops, data centers, or other locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).) For example, a franchisor may provide the types of services provided by a remote server to franchisees who own and operate particular locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data”, “content”, “bits”, “values”, “elements”, “symbols”, “characters”, “terms”, “numbers”, “numerals”, or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment and elements from different embodiments may be combined.

As used herein, the terms “comprises”, “comprising”, “includes”, “including”, “has”, “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present), and B is false (or not present), A is false (or not present), and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

As used herein, a plurality of items, structural elements, compositional elements, and/or materials may be presented in a common list for convenience. However, these lists should be construed as though each member of the list is individually identified as a separate and unique member. Thus, no individual member of such a list should be construed as a de facto equivalent of any other member of the same list solely based on their presentation in a common group without indications to the contrary.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment or example. Features of different examples may be combined.

The invention is not to be limited to the particular embodiments described herein. In particular, the invention contemplates numerous variations in the specific methodology used with respect to the deep manifold learning algorithms. The foregoing description has been presented for purposes of illustration and description. It is not intended to be an exhaustive list or limit any of the invention to the precise forms disclosed. It is contemplated that other alternatives or exemplary aspects are considered included in the invention. The description is merely examples of embodiments, processes, or methods of the invention. It is understood that any other modifications, substitutions, and/or additions can be made, which are within the intended spirit and scope of the invention.

What is claimed is:

1. An automated beverage shop, comprising:
a building structure;
a first vehicle lane;
a kiosk positioned along the first vehicle lane configured for at least one of receiving a beverage order from a customer in a vehicle at the kiosk and matching an existing order to the customer in the vehicle at the kiosk;
a drive-up window positioned along the first vehicle lane;
an automated beverage preparation control system disposed within the building structure wherein the automated beverage preparation control system is configured to:
receive an order for one or more beverages;
for each of the one or more beverages:
determine a beverage container type for the beverage,
prepare the beverage,
convey the beverage to a beverage container of the beverage container type;
convey the order for the one or more beverages to the drive-up window; and
determine that the order has been received by the customer in the vehicle.

2. The automated beverage shop of claim 1 wherein the automated beverage preparation control system is further configured to, for each of the one or more beverages, determine a lid for the beverage container type for the beverage, and control placement of the lid on the beverage.

3. The automated beverage shop of claim 1 wherein the automated beverage preparation control system is further configured to determine beverage condiments for each of the one or more beverages.

4. The automated beverage shop of claim 1 further comprising at least one actuator and wherein the automated beverage preparation control system is configured to use the at least one actuator to open and/or close the drive-up window.

5. The automated beverage shop of claim 4 further comprising at least one sensor and wherein the automated beverage preparation control system is configured to use the at least one sensor to determine if the customer has removed the one or more beverages.

6. The automated beverage shop of claim 5 further comprising a beam sensor and wherein the automated beverage preparation control system is configured to determine that a hand of the customer is not present using the beam sensor.

7. The automated beverage shop of claim 6 wherein the automated beverage preparation control system is configured to prioritize the order within a plurality of different orders using a dynamic priority queue.

8. A system for managing a plurality of automated beverage shops, comprising:
a mobile app for use by customers to place beverage orders; and
a remote server in operative communication with the mobile app wherein the remote server includes an ordering module for receiving orders through the mobile app, a membership module for managing members of users placing beverage orders, and a monitoring module for managing one or more robotic cells at each of the plurality of automated beverage shops.

9. The system of claim 8 wherein each of the plurality of automated beverage shops comprises:
a building structure;
a first vehicle lane;
a kiosk positioned along the first vehicle lane configured for at least one of receiving a beverage order from a customer in a vehicle at the kiosk and matching an existing order to the customer in the vehicle at the kiosk;
a drive-up window positioned along the first vehicle lane;
an automated beverage preparation control system disposed within the building structure wherein the automated beverage preparation control system is configured to:
receive an order for one or more beverages;
for each of the one or more beverages:
determine a beverage container type for the beverage,
prepare the beverage,
convey the order for the one or more beverages to the drive-up window; and
determine that the order has been received by the customer in the vehicle.

10. The system of claim 9 wherein the automated beverage preparation control system is further configured to, for each of the one or more beverages, determine a lid for the beverage container type for the beverage, and control placement of the lid on the beverage.

11. The system of claim 9 wherein the automated beverage preparation control system is further configured to determine beverage condiments for each of the one or more beverages.

12. The system of claim 9 further comprising at least one actuator and wherein the automated beverage preparation control system is configured to use the at least one actuator to open and/or close the drive-up window.

13. The system of claim 12 further comprising at least one sensor and wherein the automated beverage preparation control system is configured to use the at least one sensor to determine if the customer has removed the one or more beverages.

14. The system of claim 13 further comprising a beam sensor and wherein the automated beverage preparation control system is configured to determine that a hand of the customer is not present using the beam sensor.

15. The system of claim 9 wherein the automated beverage preparation control system is configured to prioritize the order within a plurality of different orders using a dynamic priority queue.

16. The system of claim 9 wherein the remote server further comprises an analysis engine and wherein the analysis engine is configured to adjust a pickup time.

17. The system of claim 16 wherein the remote server further comprises an analysis engine and wherein the analysis engine is configured to schedule inventory replenishment.

18. The system of claim 17 wherein the remote server further comprises an analysis engine and wherein the analysis engine is configured to prioritize orders using a dynamic priority queue.

19. A method of managing an automated beverage shop, the method comprising:
collecting beverage orders using a mobile app, wherein each of the beverage orders comprises a pick-up time;
dynamically scheduling preparation of the order at least partially based on the pick-up time and changes in the pick-up time;
controlling one or more robotic cells in order to automatically prepare each beverage of the beverage orders;
maintaining each beverage of the beverage orders while awaiting pickup; and
robotically delivering each of the one or more beverage orders to a customer associated therewith.

20. The method of claim 19 further comprising determining that at least one beverage of the beverage orders is outside of a predetermined temperature range while awaiting pickup, disposing of the at least one beverage and dynamically scheduling preparation of a replacement beverage prior to pick-up.
